(19) United States
(12) Patent Application Publication
(10) Pub. No.: US 2026/0021659 A1
(43) Pub. Date: Jan. 22, 2026

(54) LIQUID EJECTION SUBSTRATE, ITS MANUFACTURING METHOD, AND LIQUID EJECTION HEAD

(71) Applicant: CANON KABUSHIKI KAISHA, Tokyo (JP)

(72) Inventors: TAKASHI SUGAWARA, Kanagawa (JP); TAMAKI SATO, Kanagawa (JP); MANABU OTSUKA, Kanagawa (JP); YOSHIYUKI NAKAGAWA, Kanagawa (JP); AYAKO MARUYAMA, Kanagawa (JP)

(21) Appl. No.: 19/259,428

(22) Filed: Jul. 3, 2025

(30) Foreign Application Priority Data
Jul. 19, 2024 (JP) 2024-116236

(51) Int. Cl. B41J 2/045; B41J 2/14; B41J 2/16

(52) U.S. Cl. CPC B41J 2/04525; B41J 2/04581; B41J 2/14201; B41J 2/1607; B41J 2/1623; B41J 2002/14362; B41J 2002/14491

(57) ABSTRACT

A liquid ejection substrate including a lamination of a support substrate, a first bonding member, a flexible member having a sheet-like shape, a second bonding member, and a channel substrate having a channel through which a liquid is guided to a nozzle, in which the support substrate has a depressed portion at a position corresponding to at least a part of the channel provided to the channel substrate, and the flexible member is disposed between the channel and the depressed portion, and the first bonding member and the second bonding member are in partial contact with each other.

### BACKGROUND OF THE DISCLOSURE

### Field of the Technology

The present disclosure relates to a liquid ejection substrate, a method of manufacturing a liquid ejection substrate, and a liquid ejection head.

### Description of the Related Art

As one example of a liquid ejection head for ejecting droplets, an inkjet head mounted on an inkjet recording device is known. The inkjet head has a plurality of pressure chambers and nozzles, and is configured to eject ink droplets through the nozzles by causing a drive member to apply pressure to the ink inside of the pressure chambers.

A change in the internal pressure accompanying an ejection of ink droplet in one of the pressure chambers may propagate along a liquid channel to the other pressure chambers. The resultant what is called crosstalk may cause defective ejections.

One example of a method of reducing the effect of crosstalk includes a method of decaying such a change in the pressure using a damper. Japanese Patent No. 7196740 discloses a liquid ejection substrate in which a flexible member functioning as a damper is provided inside of a liquid channel. The flexible member disclosed in Japanese Patent No. 7196740 is held between substrates, with bonding members therebetween.

### SUMMARY

However, in the configuration disclosed in Japanese Patent No. 7196740, there is a risk of substrate delamination when the adhesiveness between the flexible member and the bonding members is low, at the position where the flexible member is held between the substrates.

The present disclosure has been made in view of such a problem. The present disclosure is made to provide a technique for suppressing delamination of a substrate when a flexible member serving as a damper is disposed in a liquid ejection substrate.

The present disclosure provides a liquid ejection substrate including a lamination of a support substrate, a first bonding member, a flexible member having a sheet-like shape, a second bonding member, and a channel substrate having a channel through which a liquid is guided to a nozzle, wherein
the support substrate has a depressed portion at a position corresponding to at least a part of the channel provided to the channel substrate, and the flexible member is disposed between the channel and the depressed portion, and
the first bonding member and the second bonding member are in partial contact with each other.

The present disclosure also provides a liquid ejection head comprising:
a liquid ejection substrate including a lamination of a support substrate, a first bonding member, a flexible member having a sheet-like shape, a second bonding member, and a channel substrate having a channel through which a liquid is guided to a nozzle, wherein the support substrate has a depressed portion at a position corresponding to at least a part of the channel provided to the channel substrate, and the flexible member is disposed between the channel and the depressed portion, and the first bonding member and the second bonding member are in partial contact with each other;
a housing configured to be capable of storing the liquid to be supplied to the channel; and
an electrical connector configured to send power and control signals to the liquid ejection substrate.

The present disclosure also provides a method of manufacturing a liquid ejection substrate, the method comprising:
forming a through-hole in a support substrate, and forming a depressed portion at a position different from the through-hole;
placing a first bonding member on a surface of the support substrate where the depressed portion is provided, but in an area in which the through-hole and the depressed portion are not provided;
placing a flexible member having a sheet-like shape, on a top surface of the first bonding member;
forming an opening in the flexible member at a position corresponding to the through-hole of the support substrate; and
placing a second bonding member on a surface of the flexible member on an opposite side of a surface bonded with the support substrate, and bringing the second bonding member into partial contact with the first bonding member via the first bonding member.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic cross-sectional perspective view of a liquid ejection substrate according to one embodiment.

FIG. 2 is an enlarged view for explaining how a flexible member is bonded.

FIG. 3 is a schematic enlarged view of the vicinity of a section that functions as a damper.

FIG. 4 is a schematic diagram illustrating how bonding members according to the one embodiment are in contact with each other.

FIGS. 5A to 5C are schematics for explaining a process of manufacturing the liquid ejection substrate according to the one embodiment.

FIGS. 6A to 6C are schematics for explaining the process of manufacturing the liquid ejection substrate according to the one embodiment.

FIG. 7 is a schematic cross-sectional front view of a liquid ejection substrate according to one embodiment.

FIGS. 8A and 8B are schematic cross-sectional front views illustrating a liquid ejection substrate according to the one embodiment.

FIG. 9 is a schematic illustrating a modification of the liquid ejection substrate.

FIGS. 10A and 10B are schematics illustrating a modification of the liquid ejection substrate.

FIGS. 11A and 11B are schematics illustrating a modification of the liquid ejection substrate.

FIGS. 12A to 12C are schematic cross-sectional front views of a liquid ejection substrate according to one embodiment.

FIGS. 13A and 13B are schematics illustrating a liquid ejection substrate according to the one embodiment.

FIG. 14 is a schematic for explaining a position where the flexible member is to be provided.

FIGS. 15A and 15B are schematics illustrating a modification of the liquid ejection substrate.

FIG. 16 is a schematic illustrating a configuration example of a liquid ejection device.

FIG. 17 is a schematic illustrating a configuration example of a liquid ejection head.

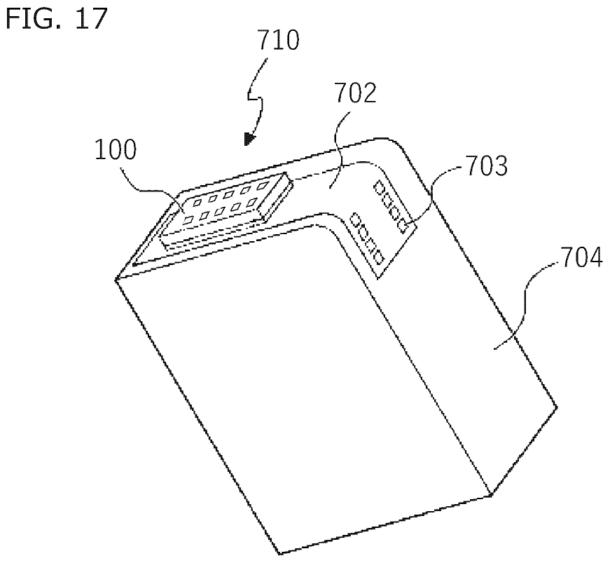

### DESCRIPTION OF THE EMBODIMENTS

Preferred embodiments of the present disclosure will now be described in detail with reference to drawings. The dimensions, materials, shapes, and relative positioning of elements described in the embodiments are not intended to limit the scope of the present disclosure to those described, except where specified otherwise. The materials, shapes, and other characteristics of members once explained in the following description remain the same throughout the following description, except where specified otherwise. Techniques that are well-known or publicly known in the art may be used for the configurations or processes that are not specifically illustrated or described. Furthermore, the present disclosure is not limited only to these embodiments, and not all of the combinations of features of the embodiments described in the embodiments are essential to the solutions provided by the present disclosure.

### First Embodiment

### Liquid Ejection Device

A liquid ejection device 600 according to this embodiment includes a liquid ejection head 710 that carries out recording on a recording medium P by ejecting liquid. The liquid ejection head 710 includes a housing having a liquid reservoir capable of storing liquid, a liquid ejection substrate provided to the bottom surface of the housing, and an electrical connector via which the power and control signals are sent to the liquid ejection substrate.

### Configurations of Liquid Ejection Device and Liquid Ejecting Head

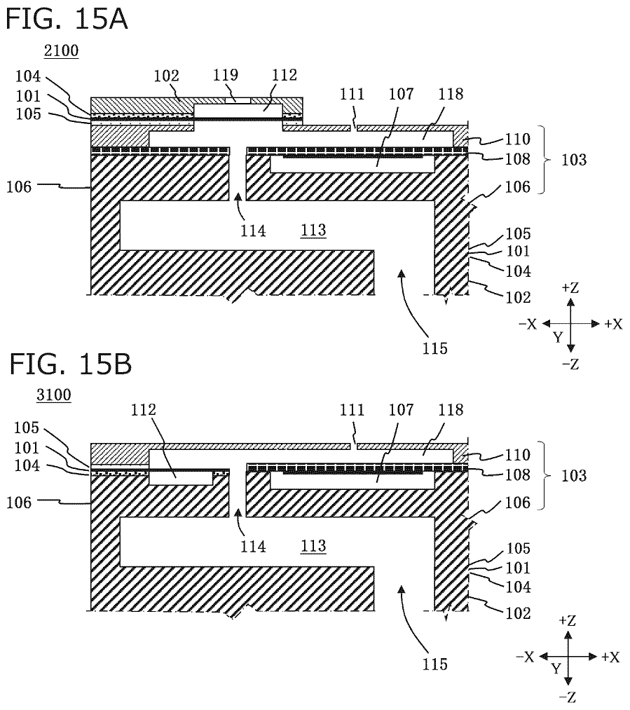

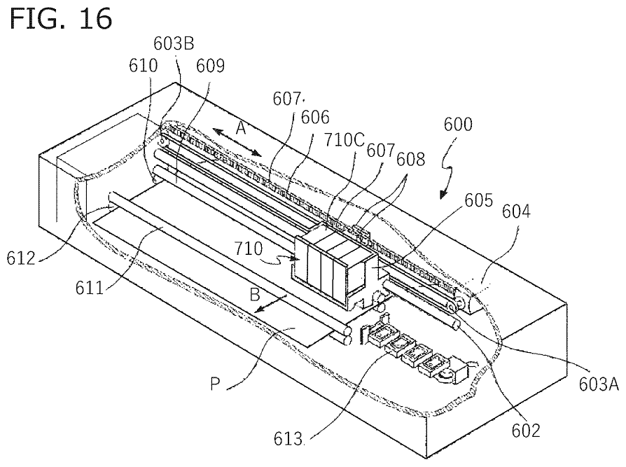

Referring to FIGS. 15A, 15B, and 16, the liquid ejection device 600 provided with the liquid ejection head 710 according to the present disclosure will now be described. In the example described herein, the liquid ejection device 600 records an image by ejecting ink to a recording medium P. FIGS. 15A and 15B are schematic cross-sectional front views illustrating a schematic configuration of the liquid ejection device 600 (recording device). FIG. 16 is a perspective view of the liquid ejection head 710 (recording head).

The liquid ejection device 600 includes a carriage 605 where the liquid ejection head 710 is detachable. The carriage 605 is mounted on a belt 606 stretched between a driving pulley 603A and a driven pulley 603B, and is provided slidably along a guide shaft 602. The belt 606 is rotated by causing the driving pulley 603A to rotate, using a carriage motor 604 as a driving source, and the carriage 605 is caused to reciprocate in the direction of the arrow A. An encoder sensor 608 detects the position of the carriage 605 in the direction A, by detecting the slits on a linear scale 607 extending along the direction A.

A first pair of conveying rollers 609, 610 and a second pair of conveying rollers 611, 612 are caused to rotate by a conveying motor, to convey the recording medium P in the direction of the arrow B. Hereinafter, the first and second pairs of conveying rollers are also referred to as a conveying roller group. The liquid ejection device 600 ejects ink via the liquid ejection head 710 onto the recording medium P in accordance with recording data, on the basis of a detection result of the encoder sensor 608, while driving the carriage motor 604. As a result, an image corresponding to one band is recorded on the recording medium P. The conveying roller group then conveys the recording medium P in the direction of the arrow B by a distance corresponding to one band. By repeating the recording operation and the conveying operation alternately, an intended image is recorded on the recording medium P.

One end of the liquid ejection device 600 in the direction A is provided with a recovery unit 613. The recovery unit 613 includes elements such as a cap member for protecting the liquid ejection head 710, and a pump for creating negative pressure inside of the cap member by drawing the ink therefrom.

Four liquid ejection heads 710 are disposed in the carriage 605 according to the present disclosure, and cyan, magenta, yellow, and black inks are respectively stored (only the liquid ejection head 710C corresponding to cyan is given the reference numeral in the drawing). With these, full-color printing is made possible. However, the scope of the present disclosure is not limited thereto, and the liquid ejection device 600 may be a device for monochromatic printing.

The liquid ejection head 710 illustrated in FIG. 16 includes a tank 704 storing therein ink, and a recording head. The recording head also includes a wiring tape 702 via which the recording data, power, and the like are supplied to a first liquid ejection substrate 100. The wiring tape 702 is provided with contacts 703, which are electrical connectors to be electrically connected to head-side contacts at the time at which the liquid ejection head 710 is mounted on the carriage 605. Note that the liquid ejection head 710 is not limited to the one in which the tank and the recording head are integrated, but may have a configuration including a separate tank and recording head.

### Description of First Liquid Ejection Substrate 100

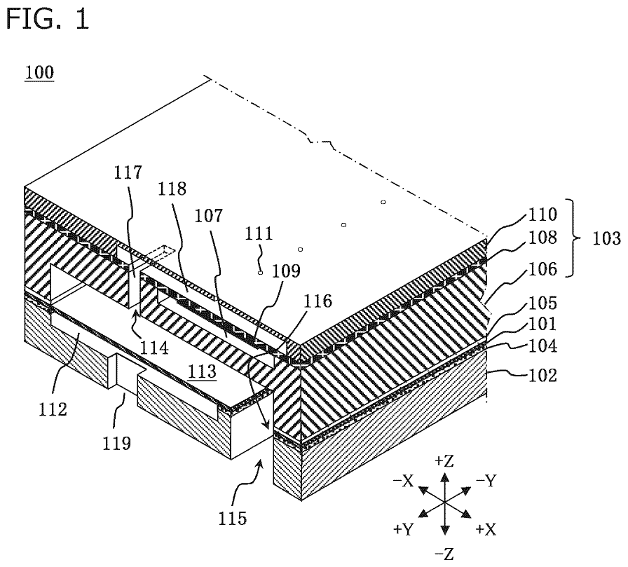

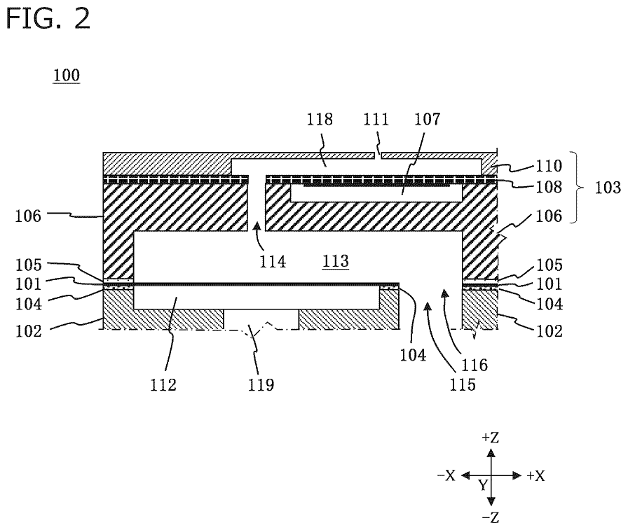

The first liquid ejection substrate 100 disposed in the liquid ejection head 710 according to this embodiment will now be explained. FIG. 1 is a schematic sectional perspective view of the first liquid ejection substrate 100. FIG. 2 is a cross-sectional view for explaining how the flexible member 101 is bonded. FIG. 2 is a schematic of the first liquid ejection substrate 100 in FIG. 1, but corresponding to a viewpoint on the +Y side. In each of the drawings in the present disclosure, the X direction corresponds to the width direction of the first liquid ejection substrate 100. The Y direction corresponds to the depth direction of the first liquid ejection substrate 100. The Z direction corresponds to the height direction of the first liquid ejection substrate 100. The surface of the first liquid ejection substrate 100 facing the +Z side will be sometimes referred to as a “top surface”. The surface of the first liquid ejection substrate 100 facing the −Z side will be sometimes referred to as a “bottom surface”. The X, Y, and Z directions are orthogonal to one another.

The liquid ejection substrate 100 according to this embodiment is also referred to as the first liquid ejection substrate 100. The first liquid ejection substrate 100 includes a support substrate 102 supporting the bottom surface of a flexible member 101, and a channel substrate 103 supporting to the top surface of the flexible member 101. Between the top surface of the support substrate 102 and the bottom surface of the flexible member 101, a first bonding member 104 is provided as a layer. Between the top surface of the flexible member 101 and the bottom surface of the channel substrate 103, a second bonding member 105 is provided as a layer. In this manner, the flexible member 101 is held and fixed between the support substrate 102 and the channel substrate 103, with the first bonding member 104 and the second bonding member 105 disposed therebetween, respectively.

The channel substrate 103 includes a first substrate member 106 the bottom surface of which has the second bonding member 105 affixed thereto. The first substrate member 106 has a housing space 107 that is recessed from the top surface toward the bottom surface. A diaphragm 108 is bonded to the top surface of the first substrate member 106, in a manner covering the housing space 107. A piezoelectric element 109 is placed on the bottom surface of the diaphragm 108. The piezoelectric element 109 is placed inside of the housing space 107.

The channel substrate 103 further includes a second substrate member 110 bonded to the top surface of the diaphragm 108. The top surface of the second substrate member 110 has a nozzle 111 for ejecting liquid as a droplet. Examples of the support substrate 102, the first substrate member 106, and the second substrate member 110 include silicon substrates. The support substrate 102 has a depressed portion 112 that is depressed portioned from the top surface toward the bottom surface of the support substrate 102, and the bottom surface of the depressed portion 112 has an atmosphere-connected port 119. At a position different from the depressed portion 112 on the support substrate 102, a third channel 115 penetrating the support substrate 102, the flexible member 101, and a part of the bottom surface side of the first substrate member 106 is provided.

The flexible member 101 has a first opening 116 via which the third channel 115 is passed to the support substrate 102 and the first substrate member 106. An example of a method of forming the first opening 116 on the flexible member 101 is dry etching. The flexible member 101 includes resin. Examples of the resin included in the flexible member 101 include polyimide and polyamide.

The flexible member 101 has the bottom surface thereof bonded to the top surface of the support substrate 102, in a manner covering the depressed portion 112. With such a configuration, when an external force due to a pressure change, to be described later, or the like is applied to the flexible member 101, the flexible member 101 is allowed to elastically deform toward the depressed portion 112. The flexible member 101 having gone through an elastic deformation can then restore its original shape, with the elastic restoring force thereof.

The first substrate member 106 is provided with a plurality of first channels 113 communicating with the first opening 116, and second channels 114 communicating with the respective first channels 113. The first substrate member 106 also has a plurality of housing spaces 107 that are arranged along the Y direction and each having a diaphragm 108 as a top surface. Each of the housing spaces 107 houses a plurality of piezoelectric elements 109 that are disposed on the bottom surface of the diaphragm 108.

The diaphragm 108 has a diaphragm opening 117 connecting the second channel 114 to the first substrate member 106 and the second substrate member 110. The second substrate member 110 also has a plurality of pressure chambers 118 having the diaphragm 108 as the bottom surface. In the second substrate member 110, a plurality of nozzles 111 communicating with the plurality of respective pressure chambers 118 are arranged in the Y direction.

With such a configuration, at the time when the liquid is to be ejected from the first liquid ejection substrate 100, the liquid is passed through the third channel 115 and the first opening 116, and is supplied to the first channel 113. The liquid supplied to the first channel 113 is then passed through the second channel 114 and the diaphragm opening 117, and is supplied into the pressure chamber 118.

The piezoelectric element 109 changes the internal volume of the pressure chamber 118 by causing the diaphragm 108 to deform in response to an electrical signal received from a controller in the main unit of the liquid ejection device 600. As a result, the pressure inside of the pressure chamber 118 changes, and the liquid inside of the pressure chamber 118 is pressurized, so that liquid droplets (for example, ink droplets) are ejected from the nozzle 111 in the +Z direction. The liquid not ejected through the nozzle 111 is recovered.

When there is a pressure change, the flexible member 101 providing one wall surface of the first channel 113 elastically deforms toward the depressed portion 112 and decays the pressure change. In other words, the entire first channel 113 serves as a damper. Because such a configuration can alleviate the pressure changes in the nozzles other than the nozzle performing the ejecting operation, it is possible to suppress the effect of the crosstalk.

As illustrated in FIG. 2, the first liquid ejection substrate 100 includes the support substrate 102, the first substrate member 106, and the second substrate member 110 that are laminated with the respective bonding members therebetween. The support substrate 102 is provided with the third channel 115, which is a liquid supply channel. The first substrate member 106 included in the channel substrate 103 is provided with the first channel 113 enabled to store the liquid supplied via the third channel 115. The second substrate member 110 is provided with the plurality of pressure chambers 118 communicating with the first channel 113. The second substrate member 110 included in the channel substrate 103 is provided with the plurality of nozzles 111 that are disposed correspondingly to the respective pressure chambers 118, and each enabled to eject the liquid stored in the corresponding pressure chamber 118. The sheet-like flexible member 101 stretched across the hollow space defined by the support substrate 102 and the first substrate member 106 (i.e., the space formed by the depressed portion 112 and the first channel 113) forms a part of a wall surface of first channel 113.

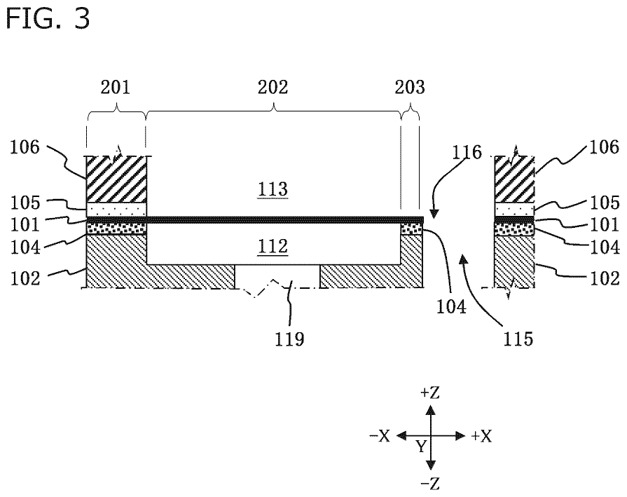

FIG. 3 is a schematic enlarged view of vicinity of a section functioning as the damper illustrated in FIG. 2. For the sake of convenience, the flexible member 101 is divided into a first section 201 bonded to the support substrate 102 and the first substrate member 106, a second section 202 forming a part of the first channel 113, and a third section 203 bonded to the support substrate 102. Of these sections, the top surface and the bottom surface of the flexible member 101 in the first section 201 are bonded to the substrates, with the bonding members therebetween. Therefore, if the adhesive force between flexible member 101 and the bonding members is weak, the flexible member 101 may delaminate from the bonding members as the flexible member 101 elastically deforms. When the flexible member 101 delaminates from the bonding members, not only the function of the flexible member 101 as a damper deteriorates, but also the substrates delaminate from each other. In view of such circumstances, in the embodiment, a characterizing bonding method is used in the first section 201.

### Configuration in Which Bonding Member is Affixed to Elastic Member and Another Bonding Member

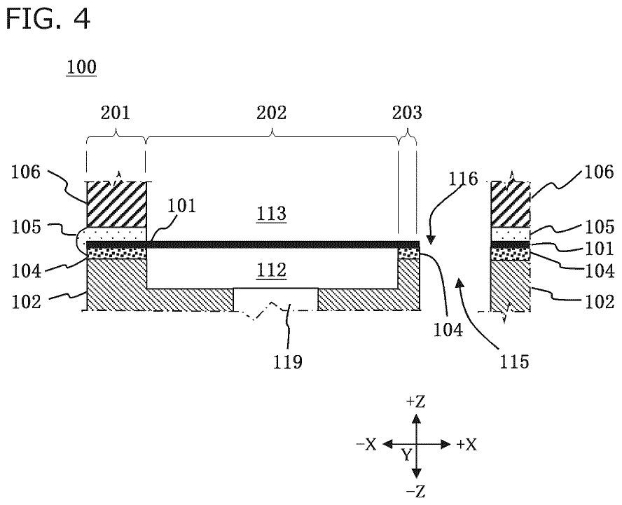

FIG. 4 is a schematic diagram illustrating how the bonding members are in contact with each other in the embodiment, and is a diagram illustrating the first liquid ejection substrate 100.

As illustrated in FIG. 4, the flexible member 101 includes the first opening 116 allowing the third channel 115 and the first channel 113 to communicate with each other in a configuration in which the support substrate 102 and the channel substrate 103 are bonded to each other.

The flexible member 101 also has the first section 201 supported in a manner being held between the support substrate 102 and the first substrate member 106. The flexible member 101 also has the second section 202 that closes the depressed portion 112, that is supported neither by the support substrate 102 nor by the first substrate member 106, and that is enabled to elastically deform toward the depressed portion 112 upon receiving an external force. The second section 202 functions as a damper section for decaying the pressure change when the liquid is ejected. The flexible member 101 also has the third section 203 the bottom surface of which is supported by the support substrate 102, and the top surface of which is not supported.

In the first section 201 in this embodiment, the first bonding member 104 having been applied to the top surface of the support substrate 102 is affixed to the bottom surface of the flexible member 101. On the top surface of the flexible member 101, by contrast, spread of the second bonding member 105 having been applied to the bottom surface of the first substrate member 106 outside of the first section 201 in the −X direction is affixed continuously to the outer peripheral side surface of the flexible member 101 in the X-direction, and to a part of the outer peripheral surface of the first bonding member 104 in the −X direction.

With such a configuration, the bonding members are allowed to come into contact with each other. Thus, even if the flexible member 101 and the bonding member in the first section 201 delaminate, because the bonding members are bonded to each other, it is possible to suppress delamination of the substrates. Furthermore, because the flexible member 101 and the second bonding member 105 are bonded by a larger area, the bonding strength can be improved, compare with that in a conventional counterpart. Therefore, with the liquid ejection substrate 100 according to the present disclosure, even when the adhesiveness between the flexible member 101 and the bonding member is low and there is a risk of delamination of substrates, the substrates can be fixed to each other firmly.

### Bonding Members

The first bonding member 104 and the second bonding member 105 will now be explained. When it is not necessary to distinguish the first bonding member 104 and the second bonding member 105, these bonding members will be simply referred to as “bonding members”. Furthermore, the support substrate 102, the first substrate member 106, and the second substrate member 110 will be simply referred to as “substrates”, where it is not necessary to distinguish one from the other.

For the bonding members, an organic or inorganic material may be used. Depending on the material used for the substrates, deterioration of the substrates may become a problem at high temperatures. Therefore, an organic material capable of bonding at a relatively low temperature is preferable, for such a material being capable of increasing the degree of freedom in the material used for the substrates. As the organic bonding member, an adhesive material may be used. However, a material that becomes bonding in a cured state is preferable, because such a material makes it easier to increase the bonding strength. A thermoplastic material is preferable because a thermoplastic material is a member that softens and becomes adhesive by heat and then solidifies by reducing the temperature, and therefore can be handled easily. A material that cures by a chemical reaction after bonding is preferable, because such a material makes it easier to enhance the bonding strength. A thermally curable material is preferable, for the curing reaction thereof being easily controllable.

As the material for the bonding member, epoxy, acrylic, urethane, silicone, benzocyclobutenes, polyimides, polyamide, polyamide-fimide, cyanoacrylate, phenol, melamine, styrene, a cyclic rubber, or a mixture thereof may be used, for example. Among these materials, a resin including epoxy, silicone, benzocyclobutene, or a polyimide, having excellent chemical resistance, as a main component is preferable.

The type of epoxy is not limited to a particular type. For example, bisphenol epoxy, epoxy novolac, epoxy polyols, an alicyclic epoxy, glycidyl epoxy, urethane-modified epoxy, chelate-modified epoxy, rubber-modified epoxy, or a mixture thereof may be used.

The type of silicone is not limited to a particular type. For example, condensation cure silicone or addition silicone may be used. Among others, addition silicone with less curing shrinkage is preferable. For example, epoxy-modified silicone, acrylic-modified silicone, methyl-based silicone, phenyl-based silicone, methyl phenyl-based silicone, alkyd-modified silicone, polyester-modified silicone, or a mixture thereof may be used.

The type of polyimide is not limited to a particular type. A thermoplastic polyimide in the form of a film may be used. It is also possible to use a polyamide acid as a precursor. It is preferable to use a precursor that becomes cured after bonding, because such a property makes it easier to enhance the bonding strength.

The bonding member may contain a filler as an additive. For example, a fibrous filler is preferable. This is because fibrous fillers are relatively effective in suppressing defects such as breakage of the bonding member. As an example of a fibrous filler, a carbon fiber, a metal fiber, a glass fiber, or a cellulose fiber may be used.

The substrate may include a functional layer, for the purpose of increasing the chemical resistance or increasing bonding force with respect to the bonding member. The functional layer may be provided to a part of the substrate. The functional layer may be provided to the entire surface of the substrate. Coupling agent may be placed between the support substrate 102 and the flexible member 101, and between the first substrate member 106 and the flexible member 101. By selecting the coupling agent suitably for the materials of the substrates or the material of the functional layer and the material of the bonding member, covalent bonds can be formed, so that the effect of enhancing the bonding force can be achieved. Needlessly to say, coupling agent may also be placed between the flexible member 101 and the first substrate member 106.

Furthermore, the bonding members used in the liquid ejection substrate according to the present disclosure may be made of the same material, but the adhesive force exerted between the second bonding member 105 and the first bonding member 104 is preferably higher than that exerted between the second bonding member 105 and the flexible member 101. With this, by bringing the second bonding member 105 into contact with the first bonding member 104 in the first section 201, the bonding strength can be improved. Furthermore, in a configuration in which the adhesive force exerted between the second bonding member 105 and the first bonding member 104 is preferably higher than that exerted between the second bonding member 105 and the flexible member 101, the bonding members may be made of different materials. In this manner, the first bonding member 104 and the second bonding member 105 can be functionally separated. For example, delamination resultant of vibration can be suppressed while improving reliability, by forming the first bonding member 104 using an elastic material for absorbing vibration of the flexible member 101, and by making the second bonding member 105 using a material exerting a high adhesive force. Method of Manufacturing Liquid Ejection Substrate

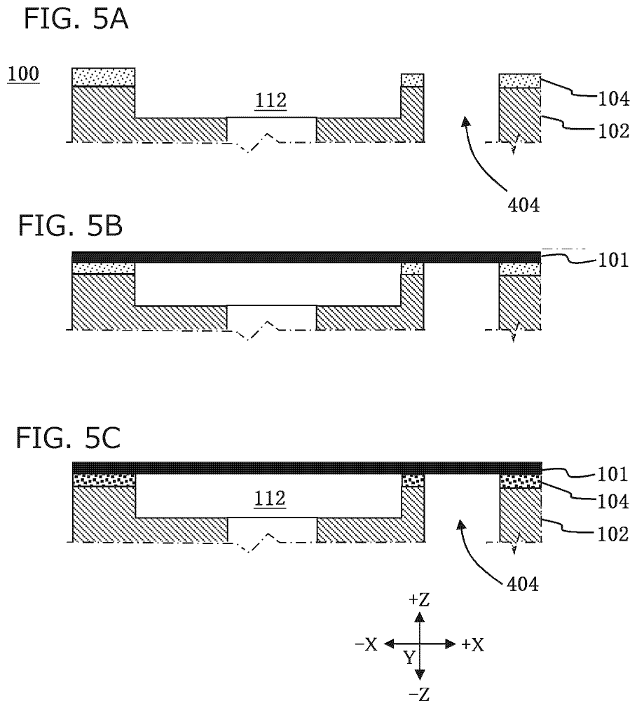

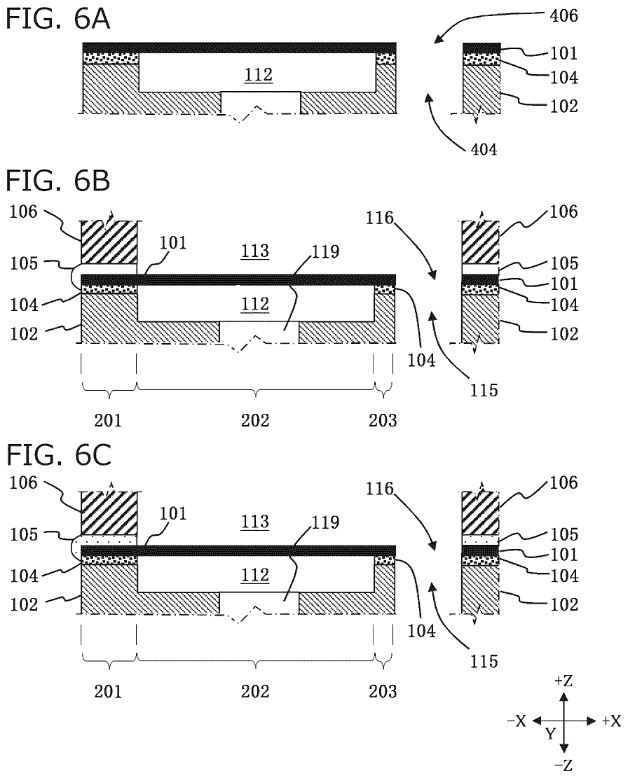

FIGS. 5A to 5C and 6A to 6C are schematics for explaining an example of a manufacturing process of the first liquid ejection substrate 100 according to this embodiment.

FIG. 5A is a schematic illustrating a first step. In the support substrate 102, the depressed portion 112 and the third channel 115 have already been formed. At this point in time, the third channel 115 is a through-hole 404 penetrating the support substrate 102. As illustrated in FIG. 5A, in the first step, uncured first bonding member 104 is applied to the support substrate 102, on the surface provided with the depressed portion 112, but in the area without the depressed portion 112 and the through-hole 404. As to the technique for applying the uncured first bonding member 104, a technique generally used for a resin member is used. To apply the first bonding member 104 to the entire surface of the support substrate 102, for example, spin coating, spraying, or the like may be used. To apply the first bonding member 104 to a part of the support substrate 102, the first bonding member 104 is applied using a dispenser, by screen printing, or transferring a dry-film of bonding member, for example.

The flexible member 101 without the opening corresponding to the first opening 116 is laid, as illustrated in FIG. 5B. At the point in time in FIG. 6A, which will be described later, an opening 406 is formed in the part to become the first opening 116 in the future. As one example of the technique for forming the opening 406, dry-etching using a mask material (not illustrated) may be used. When a photosensitive resin is used for the flexible member 101, a technique for patterning by exposure may be used.

FIG. 5B is a schematic illustrating a second step. As illustrated in FIG. 5B, in the second step, a sheet-like flexible member 101 is placed on the first bonding member 104, and the support substrate 102 and the flexible member 101 are bonded with the first bonding member 104. In the process of bonding the support substrate 102 and the flexible member 101, an appropriate temperature, pressure, or time is selected depending on the structure or thickness of the support substrate 102 or the material of the first bonding member 104. Because the first bonding member 104 may be affected by the oxygen or the like in the atmosphere, it is preferable for the support substrate 102 and the flexible member 101 to be bonded in negative pressure.

FIG. 5C is a schematic illustrating a third step. As illustrated in FIG. 5C, in the third step, the first bonding member 104 is cured. In the fourth step, the first bonding member 104 is cured by using a chemical reaction, so that the effect of enhancing the bonding force is achieved. To cure the first bonding member 104, a suitable temperature, time, atmosphere or the like may be depending on the material of the first bonding member 104. As one example of the technique for adjusting the flow of the first bonding member 104, there is a technique for rapidly heating the first support substrate 102 by irradiating the first support substrate 102 with electromagnetic waves or the like. As another example, there is a technique for curing the first bonding member 104 by irradiating the first bonding member 104 with electromagnetic waves or the like, through the first support substrate 102.

FIG. 6A is a schematic illustrating a fourth step. As illustrated in FIG. 6A, in the fourth step, an opening 406 is formed in the flexible member 101. As an example of a technique for forming the opening 406, a technique for forming the opening by dry-etching using a mask material (not illustrated) may be used. When a photosensitive resin is used for the flexible member 101, a technique for patterning by exposure may be used.

FIG. 6B is a schematic illustrating a fifth step. As illustrated in FIG. 6B, in the fifth step, the first substrate member 106 having the second bonding member 105 applied to the bottom surface along the inner periphery is bonded to the flexible member 101. By applying the second bonding member 105 to the bottom surface of the first substrate member 106, it is possible to suppress spreading of the second bonding member 105 onto the flexible member 101, which is stretched across the depressed portion 112. With this, it is possible to prevent spread second bonding member 105 from inhibiting the elastic deformation of the flexible member 101. In the fifth step, an appropriate temperature, pressure, time, and the like are selected in a manner suitable for the structure or thickness of the first substrate member 106 or the material of the second bonding member 105. Because the second bonding member 105 may be affected by the oxygen or the like in the atmosphere, it is preferable to carry out bonding under negative pressure. In the process of bonding, the uncured second bonding member 105 becomes squeezed and spreads out of the first section 201. Furthermore, as illustrated on the left side of FIG. 6B, because the uncured second bonding member 105 is low in viscosity, a part thereof flows, and comes into contact with the first bonding member 104.

FIG. 6C is a schematic illustrating a sixth step. As illustrated in FIG. 6C, in the sixth step, the second bonding member 105 is cured. In the sixth step, the second bonding member 105 is cured by using a chemical reaction, so that the effect of enhancing the bonding force can be achieved. To cure the second bonding member 105, a suitable temperature, time, atmosphere or the like may be selected on the basis of the material of the second bonding member 105. As an example of the technique for adjusting the flow of the second bonding member 105, there is a technique for rapidly heating the first substrate member 106 by irradiating the first substrate member 106 with electromagnetic waves or the like. As another example, there is a technique for curing the second bonding member 105 by irradiating the second bonding member 105 with electromagnetic waves or the like, through the first substrate member 106.

The method for providing the flexible member 101 is not limited to the example described above. Another possible technique includes preparing another support substrate 102 having a flexible member 101 formed thereon in advance, bonding the other support substrate 102 to the support substrate 102 via a bonding member, and removing the other support substrate 102.

### EXAMPLE

An example of the manufacturing method illustrated in FIGS. 5A to 5C and 6A to 6C will now be described. The following description will be made with reference to

FIGS. 5A to 5C and 6A to 6C, but following description is merely illustrative of a technically preferred example. In particular, the technical scope of the present disclosure is not limited by the following example.

As illustrated in FIG. 5A, a 625 μm silicon substrate was prepared as the support substrate 102. Positive photoresist on both sides of this silicon substrate was exposed and developed. The substrate was then dry-etched to form a depressed portion 112 having a depth of 300 μm and a width of 300 μm, and a first channel 113 having a width of 200 μm. Uncured first bonding member 104 was then formed into a dry film having a thickness of 2 μm, and transferred onto the support substrate 102. In this example, as the first bonding member 104, a thermosetting resin was applied.

As illustrated in FIG. 5B, the support substrate 102 and the flexible member 101 were then bonded to each other via the uncured first bonding member 104. As the flexible member 101, a polyimide film having a thickness of 3 μm was used, as an example. The flexible member 101 was formed by a lamination method while applying pressure. The temperature for the lamination was set to a temperature at which the cured first bonding member 104 does not cure.

The uncured first bonding member 104 was then cured, as illustrated in FIG. 5C. In this example, the first bonding member 104 was subjected to a thermal treatment at a 250° C., using a nitrogen atmosphere oven.

A mask pattern (not illustrated) was then formed on the flexible member 101, as illustrated in FIG. 6A, and the opening 406 was formed using a generally known reactive dry-etching method using a mixed gas of CF4 gas (tetrafluoromethane gas) and oxygen gas.

The first substrate member 106 with uncured second bonding member 105 applied thereon was then bonded with the flexible member 101, as illustrated in FIG. 6B. As the first substrate member 106, a silicon substrate was used, as an example. In the manner described above, the first substrate member 106 and the second substrate member 110 were formed, as illustrated in FIG. 4. At this time, the second bonding member 105 was formed at a thickness of 40 μm by dispensing a thermosetting epoxy resin that is a material having a higher adhesive force to the first bonding member 104 than to the flexible member 101. As a result of bonding the first substrate member 106 and the flexible member 101, in the first section 201, the uncured second bonding member 105 spreads out the top surface of the flexible member 101 and out of the first section 201 in the −X direction, and become continuously affixed to the outer peripheral side surface of the flexible member 101 in the −X direction and a part of the outer peripheral side surface of the first bonding member 104 in the −X direction, as well as to the top surface of the flexible member 101.

The second bonding member 105 was then cured, as illustrated in FIG. 6C. In this example, the second bonding member 105 was subjected to a thermal treatment at a 160°° C., using a nitrogen atmosphere oven.

Using the liquid ejection head 710 provided with the first liquid ejection substrate 100 manufactured as described above, ejecting operations were carried out for a predetermined time period. During this predetermined time period, the ejecting operations were performed stably. After the ejecting operations were finished, there was no observable delamination in the support substrate 102, the flexible member 101, and the first substrate member 106 of the first liquid ejection substrate 100.

### SUMMARY

As described above, with the first liquid ejection substrate 100 according to the embodiment, the second bonding member 105 that is more adhesive force to the first bonding member 104 than to the flexible member 101 is affixed continuously to the top surface of the flexible member 101, the outer peripheral side surface of the flexible member 101 in the −X direction and to a part of the outer peripheral side surface of the first bonding member 104 in the −X direction, in the first section 201 where the flexible member 101 is held between the substrates. With such a configuration, the bonding members are allowed to come into contact with each other. Thus, even if the bonding member delaminates from the flexible member 101 in the first section 201, because the bonding members are bonded to each other, it is possible to suppress delamination of the substrates. Furthermore, because the flexible member 101 and the second bonding member 105 are bonded by a larger area, the bonding strength can be improved, compare with that in a conventional counterpart. Therefore, with the liquid ejection substrate 100 according to the present disclosure, even when the adhesiveness between the flexible member 101 and the bonding member is low and there is a risk of delamination of substrates, the substrates can be fixed to each other firmly.

### Second Embodiment

A second embodiment of the present disclosure will now be described with reference to a drawing. In the following description, the same or corresponding configurations as those in the first embodiment are mentioned using the same reference signs or names, and the description thereof will be omitted as appropriate, while focusing on the description of the difference. This embodiment is different from the first embodiment in that the second bonding member 105 is in contact with the top surface of the first bonding member 104, in the first section 201.

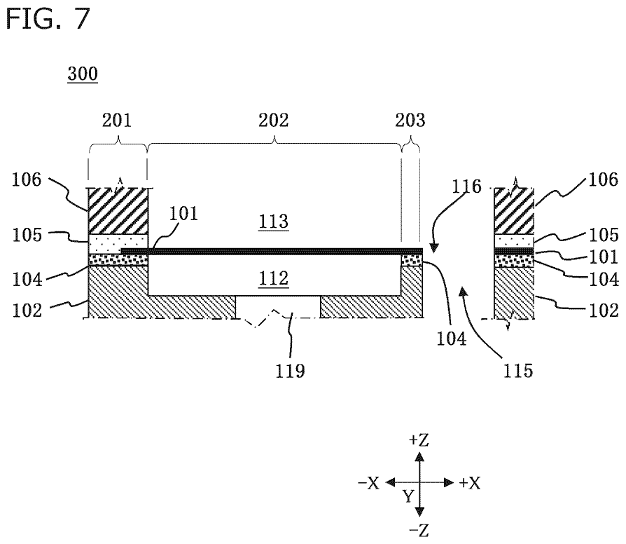

FIG. 7 is a schematic front cross-sectional view of a second liquid ejection substrate 300 according to the embodiment. As illustrated in FIG. 7, the end of the flexible member 101 in the first section 201 is at a position offset in the +X direction, toward the side of the depressed portion 112. Thus, in the first section 201, the second bonding member 105 is affixed continuously to the top surface of the flexible member 101, the side surface of the flexible member 101 in the −X direction, and the top surface of the first bonding member 104.

With such a configuration, the contact area between the second bonding member 105 and the first bonding member 104 can be increased, compared with that in the first embodiment illustrated in FIG. 4. That is, with the second liquid ejection substrate 300 according to this embodiment, the substrates can be firmly fixed to each other, at a position where the flexible member 101 is held therebetween.

### Third Embodiment

A third embodiment of the present disclosure will now be described with reference to some drawings. In the following description, the same or corresponding configurations as those in the first and the second embodiments are mentioned using the same reference signs or names, and the description thereof will be omitted as appropriate, while focusing on the description of the difference. This embodiment is different from the first embodiment in that the flexible member 101 does not have a second opening 501 in the first section 201.

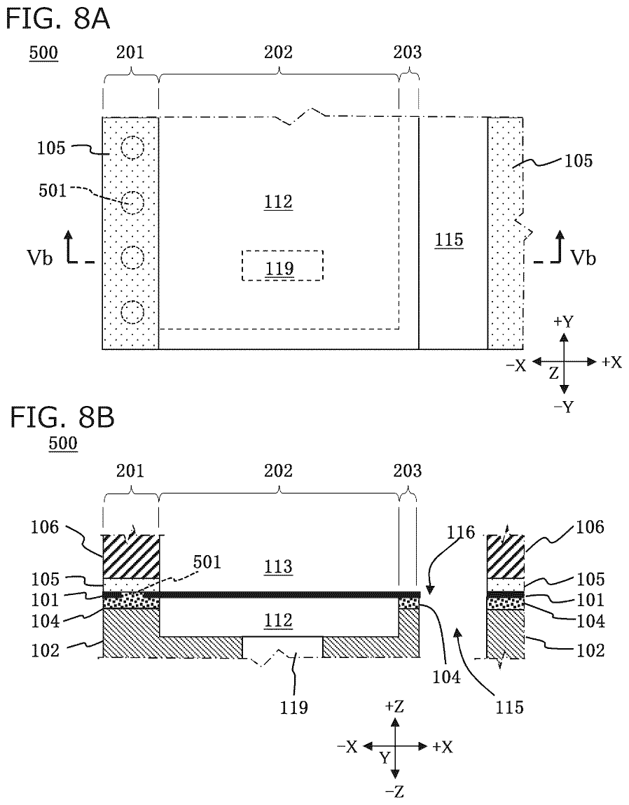

FIGS. 8A and 8B are schematic cross-sectional front views illustrating a third liquid ejection substrate 500 according to this embodiment. As illustrated in FIG. 8A, the first section 201 according to this embodiment is provided with one or more annular second openings 501. As an example of the method of forming the second openings 501 on the flexible member 101 is dry etching. There is no limitation as to the positions of the second openings 501, as long as the positions are in the first section 201. In the first section 201, the first bonding member 104 flows onto the inner peripheral surface of the second openings 501. With such a configuration, the second openings 501 are allowed to hold an extra first bonding member 104.

FIG. 8B is a cross-sectional view taken along line Vb-Vb in FIG. 8A. As illustrated in FIG. 8B, the flexible member 101 has the first opening 116 and the second openings 501, as openings. The first opening 116 allows the third channel 115 and the first channel 113 to communicate with each other in the configuration in which the support substrate 102 and the first substrate member 106 of the second channel substrate 103 are bonded to each other.

In the first section 201 according to the embodiment, the first bonding member 104 applied to the top surface of the support substrate 102 flows onto the inner peripheral surface of each of the second openings 501 that are provided on the surface to be bonded with the support substrate 102. Thus, the second bonding member 105 becomes affixed continuously to the top surface of the flexible member 101 and the top surface of the first bonding member 104.

With such a configuration, the contact area between the first bonding member 104 and the second bonding member 105 can be increased, compared with that in the first embodiment illustrated in FIG. 4. With the third liquid ejection substrate 500 according to the embodiment, the substrates can be firmly fixed to each other, at the position where the flexible member 101 is held therebetween.

### First Modification of Third Embodiment

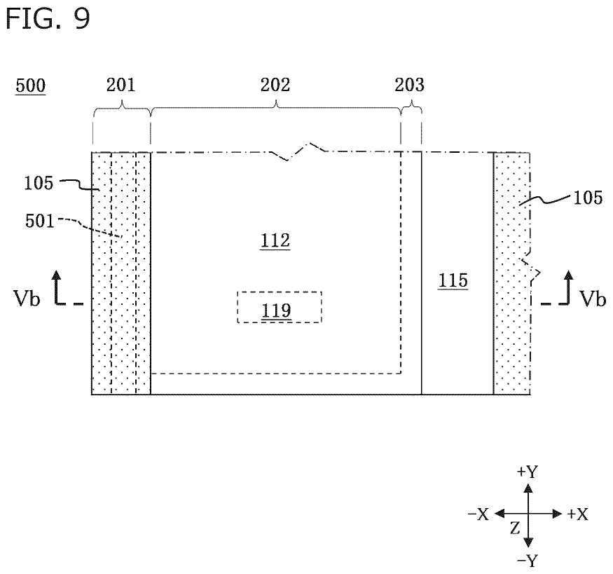

FIG. 9 is a schematic illustrating a third liquid ejection substrate 500 according to this modification. As illustrated in FIG. 9, the flexible member 101 according to this modification has a second opening 501 continuously provided along the inner side of the first section 201. That is, the second opening 501 according to this modification is an opening extending along the surface to be bonded with the support substrate 102 (see FIG. 1) in the first section 201.

With such a configuration, the second bonding member 105 is bonded to the first bonding member 104 by a larger area than that in the example in FIG. 8A. As a result, with the liquid ejection substrate in this modification, the substrates can be fixed to each other even more firmly, at the position where the flexible member 101 is held between the substrates.

### Second Modification of Third Embodiment

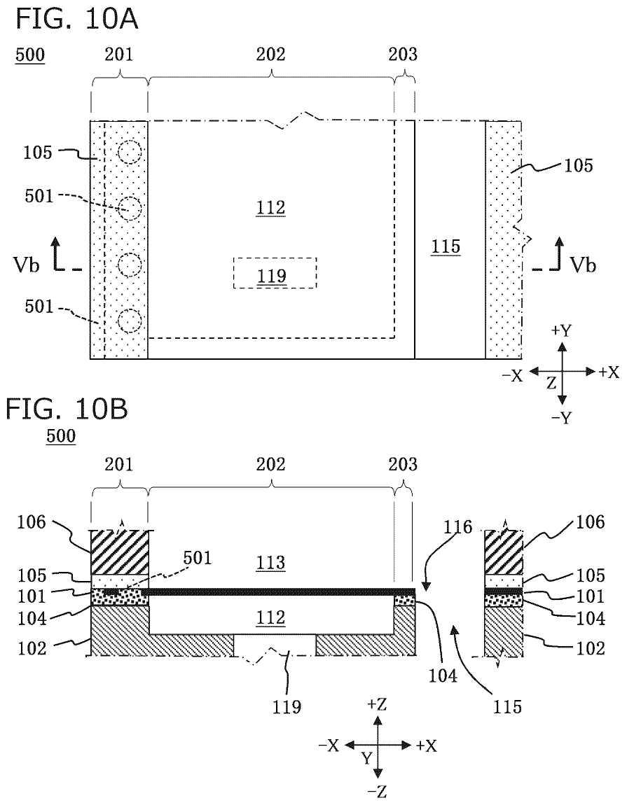

FIGS. 10A and 10B are schematics illustrating a third liquid ejection substrate 500 according to this modification. As illustrated in FIGS. 10A and 10B, the end of the flexible member 101 in the first section 201 is at a position offset in the +X direction, toward the side of the depressed portion 112. The flexible member 101 according to the modification also has one or more annular second openings 501, on the inner side in the +X direction in the first section 201.

With such a configuration, while ensuring the area for the flexible member 101 and the bonding member to be bonded to each other with the annular openings, the bonding member is bonded to the first bonding member 104 by a larger area than that in the example in FIG. 8A. As a result, with the liquid ejection substrate 100 according to this modification, the substrates can be fixed to each other even more firmly, at the position where the flexible member 101 is held between the substrates.

### Third Modification of Third Embodiment

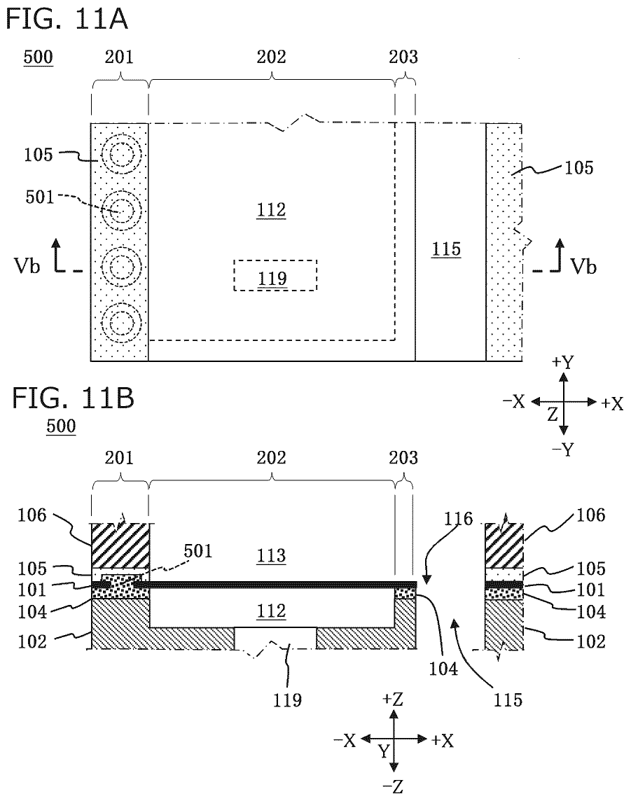

FIGS. 11A and 11B are schematics illustrating a third liquid ejection substrate 500 according to this modification. As illustrated in FIG. 11A, the first section 201 according to this embodiment is provided with one or more annular second openings 501. There is no limitation as to the positions of the second openings 501, as long as the positions are in the first section 201. In the first section 201, spread of the first bonding member 104 having passed through the second opening 501 extends on the top surface of the flexible member 101.

FIG. 11B is a cross-sectional view taken along line Vb-Vb in FIG. 11A. As illustrated in FIG. 11B, in the first section 201 according to this embodiment, the first bonding member 104 applied to the top surface of the support substrate 102 passes through the second openings 501 provided to the surface to be bonded with the support substrate 102, and extends on the top surface of the flexible member 101.

Thus, the first bonding member 104 is affixed to the bottom surface of the flexible member 101, the inner peripheral surface of the second opening 501, and the top surface of the flexible member 101, in the first section 201. That is, because the first bonding member 104 having flown into the second openings 501 extends on the top surface of the flexible member 101, the first bonding member 104 secures the flexible member 101 like an anchor. In this example, a plurality of the second openings 501 is provided in the first section 201 so as to promote this anchoring effect of the first bonding member 104.

With such a configuration, it is possible to ensure a relatively large bonding area between the support substrate 102 and the flexible member 101. Therefore, the bonding strength between the support substrate 102 and the flexible member 101 in the first section 201 can be improved, compared with that in a conventional counterpart. Moreover, because the bonding area between the first bonding member 104 and the second bonding member 105 is increased, the substrates can be firmly fixed to each other at the position where the flexible member 101 is held between the substrate.

### Fourth Embodiment

A fourth embodiment of the present disclosure will now be described with reference to some drawings. In the following description, the same or corresponding configurations as those in the embodiments described above are mentioned using the same reference signs or names, and the description thereof will be omitted as appropriate, while focusing on the description of the difference. This embodiment aims to secure the substrates to each other firmly without processing the substrates.

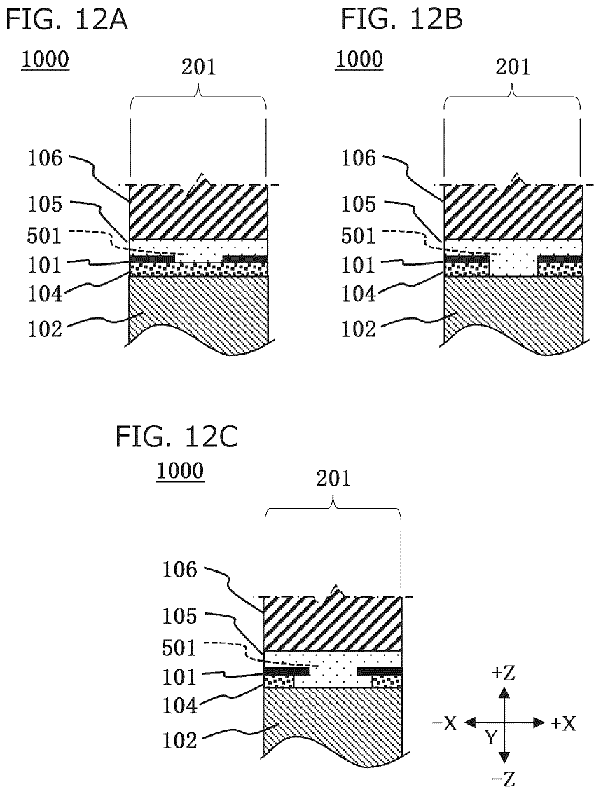

FIGS. 12A to 12C are schematic front cross-sectional views of a fourth liquid ejection substrate 1000 according to this embodiment. FIG. 12A is an enlarged view of the first section 201 of the fourth liquid ejection substrate 1000 according to this embodiment.

As illustrated in FIG. 12A, in the first section 201 according to the embodiment, the second bonding member 105 is affixed continuously to the top surface of the flexible member 101 and the inner peripheral surface of a second opening 501. The first bonding member 104 is applied to the top surface of the support substrate 102. The first bonding member 104 is, however, applied to a part where the first bonding member 104 does not get affixed to the inner peripheral surface of the second opening 501.

With such a configuration, the second bonding member 105 on the top surface of the flexible member 101 extends to the first bonding member 104, which is below the bottom surface of the flexible member 101 (in the −Z direction). Therefore, in the first section 201, the area by which the second bonding member 105 and the first bonding member 104 are bonded to each other can be increased. That is, the substrates can be firmly fixed to each other at the position where the flexible member 101 is held between the substrates.

Furthermore, because the second opening 501 can hold extra second bonding member 105, the amount of the second bonding member 105 spreading into the second section 202 can be adjusted. This configuration also prevents the second bonding member 105 from becoming affixed to the second section 202 and inhibiting the function of the second section 202 as a damper.

### First Modification of Fourth Embodiment

FIG. 12B is a schematic illustrating a fourth liquid ejection substrate 1000 according to this modification. As illustrated in FIG. 12B, in the first section 201 according to the modification, the second bonding member 105 is affixed continuously from the top surface of the flexible member 101 to the top surface of the support substrate 102, by passing through the second opening 501. In this modification, the layer of the first bonding member 104 is not provided to the part where the second bonding member 105 passes.

With such a configuration, the area by which the second bonding member 105 and the first bonding member 104 are bonded can be increased, at the position where the flexible member 101 is held between the substrates, so that the substrates can be firmly fixed to each other.

### Second Modification of Fourth Embodiment

FIG. 12C is a schematic illustrating a fourth liquid ejection substrate 1000 according to this modification. As illustrated in FIG. 12C, in the first section 201 in this modification, the second bonding member 105 is affixed continuously to the top surface of the flexible member 101, the inner peripheral surface of the second opening 501, and the support substrate 102. In this modification, the layer of the first bonding member 104 is not provided to the part where the second bonding member 105 passes.

With such a configuration, the second bonding member 105 can secure the flexible member 101 like an anchor. Therefore, with the fourth liquid ejection substrate 1000 according to this modification, delamination of the flexible member 101 can be prevented better than the examples of FIGS. 12A and 12B.

### Fifth Embodiment

A fifth embodiment of the present disclosure will now be described with reference to some drawings. In the following description, the same or corresponding configurations as those in the embodiments described above are mentioned using the same reference signs or names, and the description thereof will be omitted as appropriate, while focusing on the description of the difference. This embodiment aims to fix the substrates to each other firmly while suppressing spread, by processing the substrate.

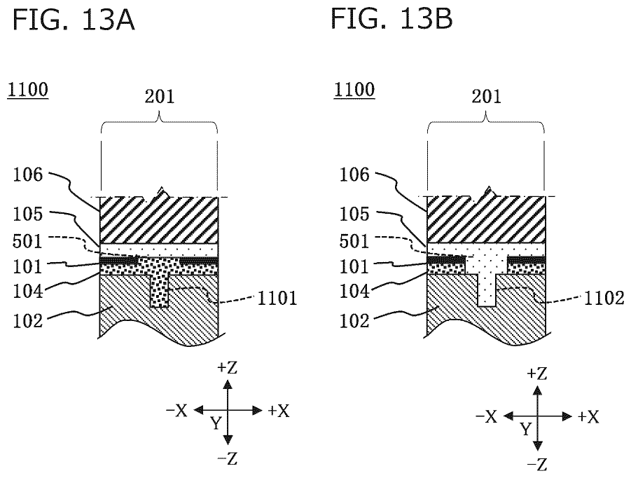

FIGS. 13A and 13B are schematic front cross-sectional views of a fifth liquid ejection substrate 1100 according to the embodiment. FIG. 13A is a schematic enlarged view of the first section 201 according to this embodiment. As illustrated in FIG. 13A, the support substrate 102 in this embodiment has a first groove 1101 with the first bonding member 104 affixed thereto. A plurality of the first grooves 1101 may be provided.

With such a configuration, it is possible to suppress spread of the first bonding member 104 into the second section 202 while the first bonding member 104 is being applied. That is, the substrates can be firmly fixed to each other, while preventing a spread of the first bonding member 104 from inhibiting the function of the damper.

### Modification of Fifth Embodiment

FIG. 13B is a view illustrating a fifth liquid ejection substrate 1100 according to this modification. As illustrated in FIG. 13B, the flexible member 101 in this modification is provided with a second opening 501. The support substrate 102 in this modification has a second groove 1102 with the second bonding member 105 affixed thereto. A plurality of the second grooves 1102 may be provided.

With such a configuration, in the first section 201 according to this modification, by applying the second bonding member 105 to the top surface of the flexible member 101, the second bonding member 105 on the top surface of the flexible member 101 extends into the second groove 1102. With such a configuration, the second bonding member 105 can secure the flexible member 101 like an anchor.

Therefore, with the fifth liquid ejection substrate 1100 according to the modification, the substrates can be firmly fixed to each other, while preventing a spread of the second bonding member 105 from inhibiting the function of the damper.

As described above, according to the embodiments of the present disclosure, the substrates can be firmly fixed to each other at the position where the flexible member 101 is held between the substrates.

### Other Embodiments

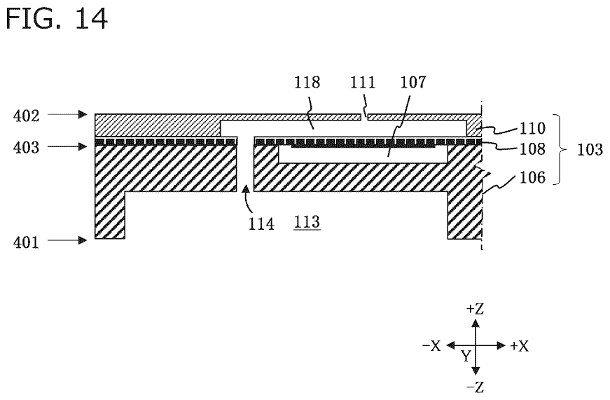

As described above, the first to fifth embodiments have illustrated a configuration in which the flexible member 101 is provided on a first surface 401, which corresponds to the bottom surface of the channel substrate 103 in the −Z direction in FIG. 14. However, the surface where the flexible member 101 and the support substrate 102 are provided is not limited to the first surface 401. For example, as illustrated in a schematic front cross-sectional view of a sixth liquid ejection substrate 2100 according to this embodiment in FIG. 15A, the flexible member 101 and the support substrate 102 may be provided to a second surface 402 corresponding to the top surface of the channel substrate 103 illustrated in FIG. 14 in the +Z direction.

Also, as illustrated in the schematic front cross-sectional view of a seventh liquid ejection substrate 3100 in this embodiment in FIG. 15B, the flexible member 101 and the support substrate 102 may be provided to a third surface 403 belonging to the same layer as the diaphragm of the channel substrate 103 illustrated in FIG. 14. In such a case, the top surface of the channel substrate 103 has a damper section where the flexible member 101 is provided, and a driving section where the housing space 107 and the diaphragm 108 are provided.

The embodiments described above may be combined as appropriate. In the embodiments described above, the support substrate 102, the first

substrate member 106, and the second substrate member 110 are provided as separate members, but these members do not need to be separate members. For example, the support substrate 102, the first substrate member 106, and the second substrate member 110 may be included in one substrate.

In the above embodiments, dry etching has been mentioned as an example of the method of forming the first opening 116 and the second opening 501 in the flexible member 101. Another possible example includes forming the first opening 116 and the second opening 501 by patterning by exposure, when the flexible member 101 includes a photosensitive resin.

In the fifth step in FIG. 6B, the first substrate member 106 having the second bonding member 105 applied to the bottom surface is bonded to the flexible member 101. In another example of the fifth step, the first substrate member 106 with the bottom surface not applied with the second bonding member 105 may be bonded to the top surface of the flexible member 101 applied with the second bonding member 105. In the embodiments described above, a piezoelectric system using a

piezoelectric element has been described as an example of the driving unit for applying pressure to the ink inside of the pressure chamber. Other examples of the driving unit for applying pressure to the ink inside of the pressure chamber include a method using an electrostatic force and a method using a heating element.

According to the present disclosure, it is possible to provide a technique for suppressing delamination of a substrate when a flexible member serving as a damper is disposed in a liquid ejection substrate.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-116236, filed on Jul. 19, 2024, which is hereby incorporated by reference wherein in its entirety.

What is claimed is:

1. A liquid ejection substrate including a lamination of a support substrate, a first bonding member, a flexible member having a sheet-like shape, a second bonding member, and a channel substrate having a channel through which a liquid is guided to a nozzle, wherein
the support substrate has a depressed portion at a position corresponding to at least a part of the channel provided to the channel substrate, and the flexible member is disposed between the channel and the depressed portion, and
the first bonding member and the second bonding member are in partial contact with each other.

2. The liquid ejection substrate according to claim 1, wherein adhesive force between the second bonding member and the first bonding member is higher than adhesive force between the second bonding member and the flexible member.

3. The liquid ejection substrate according to claim 1, wherein the second bonding member disposed on a top surface of the flexible member is in continuous contact with an end of the flexible member and an end of the first bonding member, on an outer peripheral side surface of the liquid ejection substrate.

4. The liquid ejection substrate according to claim 1, wherein, establishing a direction in which the first bonding member, the flexible member, and the second bonding member are laminated as a first direction, and establishing a direction orthogonal to the first direction as a second direction, at least a part of an end of the flexible member in the second direction is positioned between an outer peripheral side surface of the liquid ejection substrate and an end of the depressed portion.

5. The liquid ejection substrate according to claim 1, wherein
the flexible member is provided with an opening in a section bonded with the second bonding member, and
at least one of the first bonding member and the second bonding member is disposed inside of the opening, so that the first bonding member and the second bonding member are in contact with each other in the opening.

6. The liquid ejection substrate according to claim 5, wherein a plurality of the openings is provided along a bonding surface between the flexible member and the support substrate.

7. The liquid ejection substrate according to claim 5, wherein the opening extends along a bonding surface between the flexible member and the support substrate.

8. The liquid ejection substrate according to claim 5, wherein
a plurality of the openings is provided along a bonding surface with the support substrate, and
establishing a direction in which the first bonding member, the flexible member, and the second bonding member are laminated as a first direction, and establishing a direction orthogonal to the first direction as a second direction, at least a part of an end of the flexible member in the second direction is positioned between an outer peripheral side surface of the liquid ejection substrate and an end of the depressed portion.

9. The liquid ejection substrate according to claim 5, wherein the first bonding member is in continuous contact with a bottom surface and a top surface of the flexible member, and with an inner peripheral surface of the opening.

10. The liquid ejection substrate according to claim 1, wherein
the flexible member is provided with an opening in a section bonded with the second bonding member, and
the first bonding member is provided with a groove in a section corresponding to the opening, and the second bonding member is disposed inside of the groove provided to the first bonding member.

11. The liquid ejection substrate according to claim 1, wherein the support substrate is provided with a groove in a section bonded with the first bonding member, and the first bonding member is disposed inside of the groove provided to the support substrate.

12. The liquid ejection substrate according to claim 1, wherein
the flexible member is provided with an opening in a section bonded with the second bonding member,
the first bonding member is provided with a groove extending to the support substrate, in an area corresponding to the opening, and
the second bonding member is in contact with the support substrate through the opening of the flexible member and the groove of the first bonding member.

13. The liquid ejection substrate according to claim 1, wherein the first bonding member and the second bonding member are made of the same material.

14. The liquid ejection substrate according to claim 1, wherein the first bonding member is a member having higher flexibility than the second bonding member, and the second bonding member is a member having higher adhesive force to the flexible member than the first bonding member.

15. The liquid ejection substrate according to claim 1, wherein the channel substrate includes a plurality of the nozzles, a plurality of pressure chambers corresponding to the plurality of the nozzles, a second channel configured to guide the liquid to the plurality of the pressure chambers through the channel, and a plurality of driving units disposed inside of the plurality of the pressure chambers and configured to cause the ink to be ejected by applying pressure to the liquid.

16. The liquid ejection substrate according to claim 1, wherein the liquid ejection substrate includes a lamination of the support substrate, the first bonding member, the flexible member, the second bonding member, and the channel substrate that are laminated in an order listed herein.

17. The liquid ejection device according to claim 1, wherein
the liquid ejection substrate includes a lamination of the channel substrate, the second bonding member, the flexible member, the first bonding member, and the support substrate that are laminated in an order listed herein, and
the nozzle is provided in a section where the second bonding member is not disposed, on a top surface of the channel substrate.

18. The liquid ejection substrate according to claim 1, wherein in the liquid ejection substrate, the channel substrate includes a damper section including a lamination of the first bonding member, the flexible member, and the second bonding member, and a driving section provided with a driving unit configured to cause the liquid to be ejected by applying pressure to the liquid, and
the support substrate is laminated on top surfaces of the damper section and the drive section.

19. A liquid ejection head comprising:
a liquid ejection substrate including a lamination of a support substrate, a first bonding member, a flexible member having a sheet-like shape, a second bonding member, and a channel substrate having a channel through which a liquid is guided to a nozzle, wherein the support substrate has a depressed portion at a position corresponding to at least a part of the channel provided to the channel substrate, and the flexible member is disposed between the channel and the depressed portion, and the first bonding member and the second bonding member are in partial contact with each other;
a housing configured to be capable of storing the liquid to be supplied to the channel; and
an electrical connector configured to send power and control signals to the liquid ejection substrate.

20. A method of manufacturing a liquid ejection substrate, the method comprising:
forming a through-hole in a support substrate, and forming a depressed portion at a position different from the through-hole;
placing a first bonding member on a surface of the support substrate where the depressed portion is provided, but in an area in which the through-hole and the depressed portion are not provided;
placing a flexible member having a sheet-like shape, on a top surface of the first bonding member;
forming an opening in the flexible member at a position corresponding to the through-hole of the support substrate; and
placing a second bonding member on a surface of the flexible member on an opposite side of a surface bonded with the support substrate, and bringing the second bonding member into partial contact with the first bonding member via the first bonding member.
